(19) United States
(12) Patent Application Publication
(10) Pub. No.: US 2005/0025465 A1
(43) Pub. Date: Feb. 3, 2005

(54) Enhanced functionality for audio/video content playback

(76) Inventor: Damon V. Danieli, Clyde Hill, WA (US)

Correspondence Address: LEE & HAYES PLLC, 421 W RIVERSIDE AVENUE SUITE 500, SPOKANE, WA, 99201, US

(21) Appl. No.: 10/632,890

(22) Filed: Aug. 1, 2003

(51) Int. Cl. H04N 5/781

(52) U.S. Cl. 386/125; 386/126

(57) ABSTRACT

Enhanced functionality for audio/video content playback includes, in accordance with one aspect, receiving audio/video content for playback. Programmatic data associated with the audio/video content is also received. A set of instructions is executed to enhance the playback of the audio/video content, wherein the enhancement is based at least in part on the programmatic data.

### TECHNICAL FIELD

This invention relates to content playback, and particularly to enhanced functionality for audio/video content playback.

### BACKGROUND

Content recording and playback devices that allow users to record and/or playback movies, television programs, and other content are commonly available. Such devices allow for the recording and/or playback of content that is recorded by the users themselves or alternatively acquired from some other source (e.g., borrowed, purchased or rented). Such devices may be analog devices (e.g., a video cassette player or video cassette recorder (VCR)) or digital devices (e.g., a Digital Versatile Disc (DVD) player or recorder).

The higher video and audio quality supported by DVD over many analog formats, as well as the ease and speed with which different portions of a DVD can be accessed, has made DVDs very popular. However, the functionality offered by DVDs is still fairly limited. For example, a user is typically limited to being able to play/pause playback of the audio/video (AV) content on the DVD, fast forward through the AV content, rewind through the AV content, or jump to a particular point in the AV content. In order to improve the user's experience when playing back content from DVDs, as well as other sources, it would be beneficial to expand the functionality provided to the user in playing back such content.

### SUMMARY

Enhanced functionality for audio/video content playback is described herein.

In accordance with one aspect, audio/video content is received for playback. Programmatic data associated with the audio/video content is also received. A set of instructions is executed to enhance the playback of the audio/video content, wherein the enhancement is based at least in part on the programmatic data.

### BRIEF DESCRIPTION OF THE DRAWINGS

The same numbers are used throughout the document to reference like components and/or features.

FIG. 1 is a block diagram illustrating an example environment in which the enhanced functionality as described herein can be made available.

FIG. 2 is a flowchart illustrating an example of a process for enhancing the functionality of audio/video content playback.

FIG. 3 illustrates an example of implementing enhanced functionality for AV content playback where the programmatic data and AV content are part of the same data stream.

FIG. 4 illustrates an example of implementing enhanced functionality for AV content playback where the programmatic data and AV content are different data streams.

FIG. 5 illustrates another example of implementing enhanced functionality for AV content playback where the programmatic data and the AV content are different data streams.

FIG. 6 illustrates an exemplary general device.

### DETAILED DESCRIPTION

As described herein, audio/video (AV) content is made available to users, such as by distribution of digital versatile discs (DVDs) that include the AV content. In addition to the AV content, a set of instructions is also made available to the playback device. The set of instructions, when executed by the playback device, causes the playback device to process programmatic data associated with the AV content. This programmatic data may be stored on the same source as the AV content, or alternatively stored elsewhere. The execution of this programmatic data allows enhanced functionality related to the AV content to be made available to the user, as discussed in more detail below.

General System

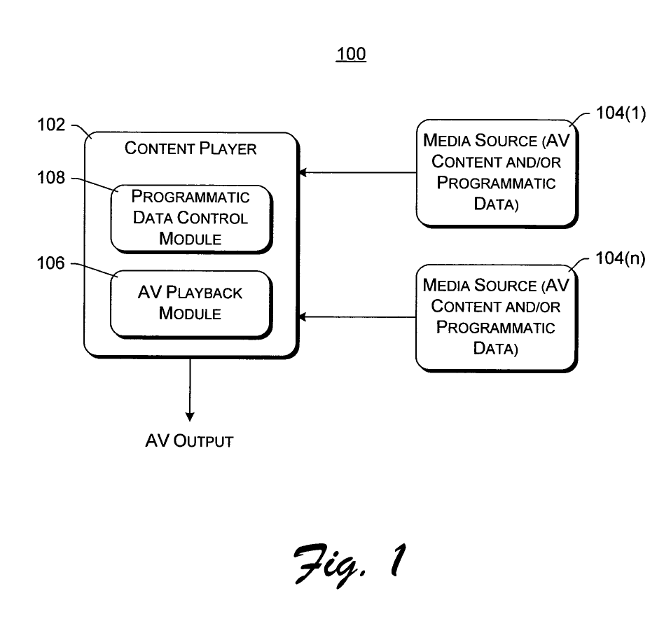

FIG. 1 is a block diagram illustrating an example environment 100 in which the enhanced functionality as described herein can be made available. In environment 100, a content player 102 receives data from one or more media sources 104(1), . . . , 104(n). Media sources 104 can be the same type of source or alternatively different types of sources. Examples of media sources 104 include transmission sources (e.g., satellite or cable transmitters, radio frequency (RF) transmitters, streaming media servers accessible over the Internet, etc.) and distribution sources (e.g., optical discs such as DVDs, magnetic disks or tapes, etc.).

Content player 102 receives at least three types of data from media sources 104: AV content, programmatic data, and a set of instructions. This various data can be received from the same media source 104, or alternatively from different media sources 104. For example, the AV content and set of instructions may be received from one media source 104 (e.g., a DVD), while the programmatic data is received from another media source 104 (e.g., a network server). The set of instructions, also referred to herein as an executable, is typically received from the same media source as the AV content, although the set of instructions may alternatively be received from a different media source. The set of instructions are executed to process the programmatic data, as discussed in more detail below. Although referred to herein as an executable or the set of instructions being executed, it is to be appreciated that the instructions may be in some other form, such as an interpreted program that is to be translated by an interpreter of content player 102.

The AV content refers to the audio and visual content that is to be presented to the user as the AV programming. The AV programming can be any of a variety of types of AV content, such as a movie (including home-movies (e.g., made with a camcorder or computer), movies made for television, movies made for theatrical release, movies made for the home-entertainment market, etc.), other television programs (e.g., sitcoms, news broadcasts, sporting events, documentaries, home shopping channels, etc.), and so forth.

Typically, such as when the media source is a DVD, the AV content is made up of an AV stream that includes a video track having the video data to be displayed to the user, and an audio track having the audio data to be audibly played to the user. A media source may have multiple audio and/or video tracks for particular AV programming. For example, different audio tracks may be associated with the same video track, such as audio tracks being in different languages, or a director's commentary regarding the AV programming. By way of another example, different quality video tracks (e.g., obtained using different compression ratios) may be associated with the same audio track. Typically, the AV stream received by content player 102 includes a single audio track and a single video track, although alternatively a stream may include multiple audio tracks and/or multiple video tracks.

During operation, content player 102 includes an AV playback module 106 and a programmatic data control module 108. AV playback module 106 processes and outputs the AV content for presentation to the user. AV playback module 106 receives the AV stream from media source 104 (and/or module 108, as discussed in more detail below) and converts the data in the received audio and video tracks to an appropriate format for audible and visual playback to the user. Content player 102 may include the hardware for presenting the AV content to the user (e.g., a display device and a speaker), or alternatively content player 102 may generate an AV output to one or more other devices for the one or more other devices to present the AV content to the user.

Programmatic data control module 108 is the set of instructions that are received by content player 102. The set of instructions are loaded into content player 102 from a media source(s) 104. The set of instructions may be loaded into content player 102 at any time so long as they are available when the programmatic data is to be processed. Typically, the set of instructions are loaded when the media source 104 is first accessible to content player 102 (e.g., when the DVD is first loaded into content player 102, or a streaming media server is first accessed by content player 102). Programmatic data control module 108 processes the programmatic data received by content player 102, and operates to carry out the functionality described by the programmatic data. Depending on the particular enhanced functionality provided by the programmatic data, this processing of the programmatic data may optionally involve operating on the AV content as well, as discussed in more detail below.

The set of instructions for all of the enhanced functionality associated with particular AV content are typically loaded into content player 102 together. Alternatively, different sets of instructions may be used for different enhanced functionality associated with the AV content, and the individual sets may be loaded into content player 102 only when that enhanced functionality is invoked by the user.

Furthermore, it should be noted that, based on the capabilities of content player 102, the set of instructions for multiple different AV content may be maintained by player 102 concurrently. For example, the AV content may be uniquely identified (e.g., based on a unique id assigned to AV content received from a media server, or based on the data stored on the DVD on which the AV content is stored) and this identifier may be associated with the set of instructions saved to a nonvolatile storage device (e.g., a hard disk) of content player 102. By so saving the set of instructions, the set of instructions need not be re-loaded on content player 102 when the AV content is subsequently accessed by content player 102 (e.g., when the user next desires to playback the AV content).

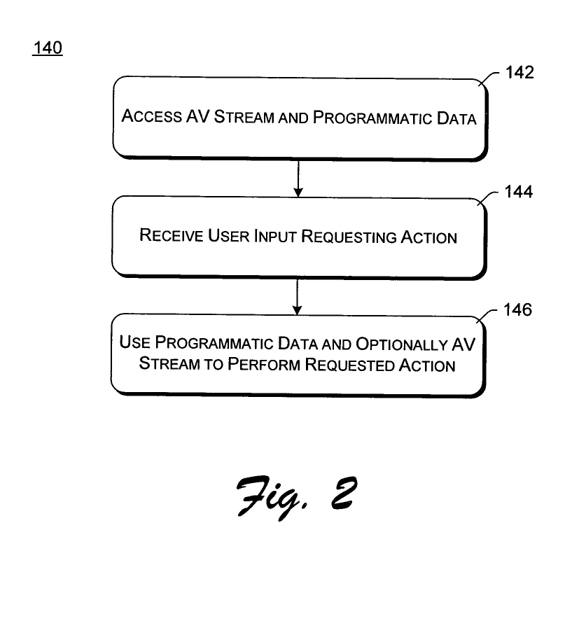

FIG. 2 is a flowchart illustrating an example of a process 140 for enhancing the functionality of audio/video content playback. The process of FIG. 2 is implemented by content player 102 of FIG. 1, and may be performed in hardware, software, firmware, or combinations thereof.

Initially, an AV content stream and programmatic data are accessed (act 142). As discussed above, the AV content stream and programmatic data may be accessed from the same media source or alternatively different media sources. A user input requesting an action(s) is also received (act 144). Any of a variety of actions may be requested by the user. These actions may be traditional actions for navigating playback of the AV content (e.g., stop, pause/play, fast forward, rewind, etc.), or may be other actions specifically requesting particular enhanced functionality (e.g., requesting intelligent scanning, requesting automatic recap or summary, etc.). Examples of this enhanced functionality are discussed in additional detail below.

The user can input such requests in any of a variety of manners. For example, the user may have access to a remote control device that communicates (e.g., via infrared (IR) or radio frequency (RF)) with content player 102. This remote control device can have various buttons (e.g., having functionality defined by the manufacturer or reseller of the remote control device, or by the user) that can be selected by the user to cause the particular request to be input. By way of another example, the user may have a handheld game controller (e.g., for use with a gaming device) having one or more of a joystick(s), button(s), and trigger(s). A button or trigger may be defined with a particular request, or alternatively the user may control an on-screen pointer with the handheld game controller (and thus navigate the pointer to a particular selection, such as an on-screen button or menu, and select the desired request by activating a button or trigger on the controller).

When the user input is received, the programmatic data and optionally the AV stream are used to perform the requested action (act 146). The exact operations that are carried out to perform the requested action can vary based on the enhanced functionality being invoked. Specific examples of such enhanced functionality are described in additional detail below.

It should be noted that the order in which acts 142, 144, and 146 are illustrated in FIG. 2 does not imply any particular required order in which the acts are to be carried out. Multiple acts may be carried out concurrently (e.g., acts 142 and 144 may be performed at the same time), or the acts may be performed in an order different than the illustrated order (e.g., act 144 may occur prior to at 142).

The enhanced functionality for AV content playback described herein is made possible by use of the set of instructions and programmatic data associated with the AV content. However, the structure of the AV content itself need not be altered from current standards. For example, the AV content on a DVD that supports the enhanced functionality described herein would be the same audio and video tracks as on a DVD that does not support the enhanced functionality described herein. Thus, if a DVD that supports the enhanced functionality described herein is played back on a DVD player that does not understand the programmatic data or the set of instructions (such DVD players are also referred to as legacy devices), the DVD player can still access and playback the AV content from the DVD. However, if a DVD that supports the enhanced functionality described herein is played back on a DVD player that does understand the programmatic data and the set of instructions, then the enhanced functionality described herein is made available to the user of that DVD player.

Example Implementations

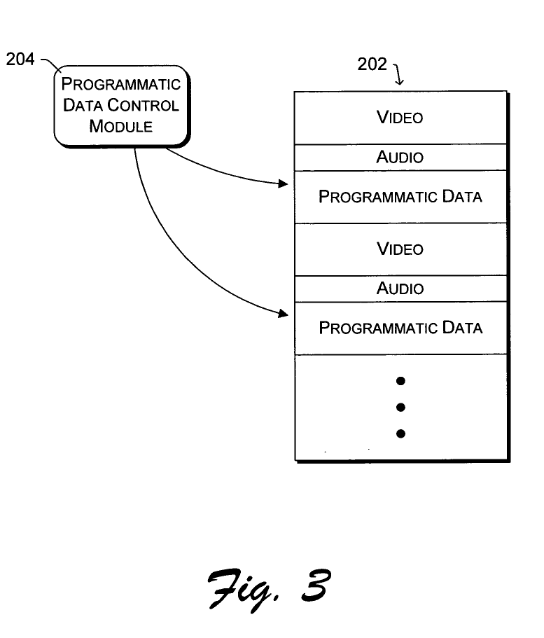

The enhanced functionality described herein can be implemented in a variety of different manners. FIGS. 3, 4, and 5 illustrate three example implementations, although different implementations may alternatively be employed.

FIG. 3 illustrates an example of implementing enhanced functionality for AV content playback where the programmatic data and AV content are part of the same data stream. The AV content and programmatic data stream 202 is received from the same source (e.g. from a single DVD) and, as illustrated, are part of the same stream. For example, the AV content and programmatic data may be received as a single stream that includes an audio track(s), a video track(s) and a programmatic data track(s). During playback of the audio and video tracks, programmatic data control module 204 extracts the programmatic data for processing. It should be noted, however, that the programmatic data is not processed until a user input requesting an action is received (although such a request may be a request to play the AV content).

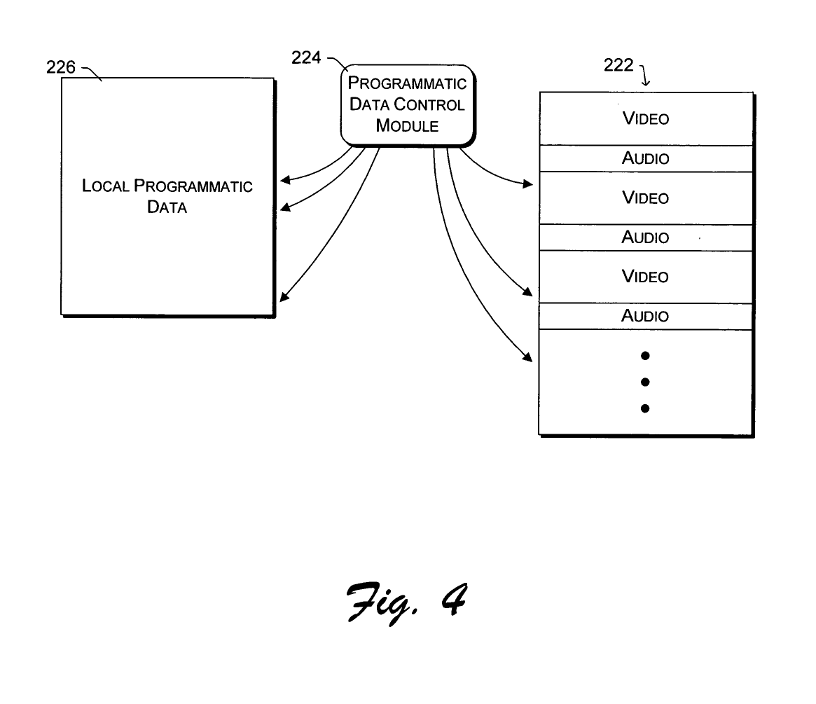

FIG. 4 illustrates an example of implementing enhanced functionality for AV content playback where the programmatic data and AV content are different data streams. The AV content stream 222 includes an audio track(s) and a video track(s), while the programmatic data stream 226 is a separate stream. The programmatic data stream 226 is obtained locally as is AV content stream 222, and the streams 226 and 222 may be obtained from the same media source (e.g., the same DVD) or alternatively different media sources (e.g., AV content stream 222 may be obtained from a DVD while programmatic data stream 226 is obtained from a local hard drive).

During playback of the AV content, programmatic data control module 224 monitors the AV content stream 222 and uses location identifiers from AV content stream 222 to index into local programmatic data stream 226. In one implementation, these location identifiers are temporal location identifiers. AV content stream 222 is time indexed in some manner (e.g., in accordance with any of the DVD standards), and this indexing can be used to map or index into the local programmatic data. For example, local programmatic data 226 and/or executable 224 can include a mapping of AV content stream 222 location identifiers to programmatic data. Based on the current location of AV content stream 222 being played back, the corresponding programmatic data 226 can be readily identified and processed by programmatic data control module 224.

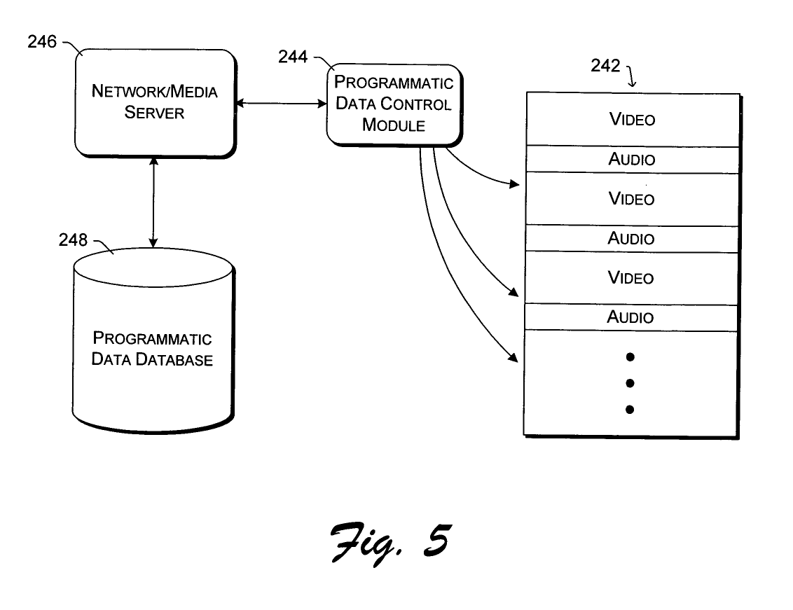

FIG. 5 illustrates another example of implementing enhanced functionality for AV content playback where the programmatic data and the AV content are different data streams. FIG. 5 is similar to FIG. 4, except that the programmatic data is obtained from a remote media source. Programmatic data control module 244 uses a location identifier of the current location of AV content stream 242 being played back to map into the programmatic data, similar to programmatic data control module 224 of FIG. 4. However, to access the programmatic data, programmatic data control module 244 accesses a programmatic data database 248 by way of a server 246. The programmatic data may be accessed on-the-fly (e.g., the current programmatic data is determined based on the current playback location of the AV stream 242), or portions (or all) of the programmatic data corresponding to AV stream 242 may be downloaded and made available locally to programmatic data control module 244.

Regardless of the way in which the example functionality is implemented (e.g., in accordance with any of the examples of FIGS. 3, 4, and 5, the enhanced functionality can be invoked in any of a variety of manners. The particular manner in which particular enhanced functionality is invoked can vary based on the type of functionality as well as the desires of the AV content developer (and/or the developer of the programmatic data, and/or the developer of the programmatic data control module, etc.). Different types of functionality may be invoked in different manners even though associated with the same AV content.

Examples of the way enhanced functionality can be invoked include: activation of a navigation button on a remote control device or on content player 102 (e.g., buttons for play, pause, stop, fast forward, rewind, etc.); activation of a virtual button displayed on-screen (e.g., displayed on the same display device as the AV content or alternatively on some other device), such as a navigation button or some other button; activation of a specialized or dedicated button (a virtual button displayed on-screen, a button on a content player 102, a button on a remote control device, etc.), such as a scan button (to invoke the Intelligent Scanning functionality), a virtual walkthrough button (to invoke the Virtual Walkthrough on Rails functionality), a takeover button (to invoke the Takeover Action functionality), etc.; activation of a button, trigger, joystick, etc. on a game controller (e.g., moving the joystick to invoke the Freeform exploration of the World functionality, pressing a trigger or button to invoke the Episodic Download of Additional Content functionality, etc.); and so forth.

Similarly, once the enhanced functionality is invoked, the enhanced functionality may be controlled in any of a variety of manners. The particular manner in which particular enhanced functionality is controlled can vary based on the type of functionality as well as the desires of the AV content developer (and/or the developer of the programmatic data, and/or the developer of the programmatic data control module, etc.). Different types of functionality may be controlled in different manners even though associated with the same AV content.

Examples of the way enhanced functionality can be controlled include: automatic control (e.g., once invoked nothing more needs to be done by the user), such as for the Different Aspect Ratios functionality or the HDTV Version Video functionality; selection of a virtual button, menu item, link, or other item displayed on-screen (e.g., displayed on the same display device as the AV content or alternatively on some other device), such as a navigation button or some other button; selection of a specialized or dedicated button (a virtual button displayed on-screen, a button on a content player 102, a button on a remote control device, etc.), etc.; activation of a button, trigger, joystick, etc. on a game controller (e.g., moving the joystick to move around using the Freeform exploration of the World functionality, etc.); and so forth.

Additionally, depending on the device(s) available to the user, the programmatic data may be accessed in different ways, such as allowing particular enhanced functionality based on the types of devices available to the user and/or being used by the user. For example when the user has a DVD remote control, the user can access enhanced functionality such as 360 Degree Pause, Intelligent Scanning, Multiform Stories, etc., whereas if the user has a game controller, the user can have access to enhanced functionality such as Takeover Action, Freeform Exploration, etc., and if the user has a headset (e.g., including one or more speakers and/or a microphone), the user can have access to enhanced functionality such as Multiplayer Worlds, Character Innerdialog, etc.

Example Functionality

Any of a variety of enhanced functionality for AV content playback can be made available by the set of instructions and programmatic data associated with the AV content. Several examples of such enhanced functionality are included in this section. However, it is to be appreciated that these are merely examples, and that other types of enhanced functionality may also be made available. Additionally, it should be noted that different AV content may be associated with different types of enhanced functionality, and that different versions of the same AV content (e.g., on different distribution media) may be associated with different types of enhanced functionality. For example, a movie on one DVD may have both the Infopause and Intelligent Scanning functionality, while the same movie on a different DVD may have the Multiplayer Worlds and Takeover Action functionality.

Many of the example functionalities discussed herein refer to what a particular user can do. It is to be appreciated that multiple users may be using a 11 single content player 102 concurrently, and that these multiple users may invoke different enhanced functionalities. For example, two users may invoke the Character Innerdialog functionality for different characters, or one user may invoke the Character Innerdialog functionality while the other user invokes the Takeover Action functionality.

### Enhancement of Content Stream Quality

The quality of the video in the AV output from content player 102 can be enhanced by using programmatic data in the form of an additional track(s) or stream(s) that, when combined with a track of the AV content, improves the quality of the picture and/or the quality of the audio output by using a processor of content player 102. As the AV content is received, programmatic data control module 108 adds in additional detail (based on the programmatic data) to the audio and/or video track of the AV content in order to improve the quality of the particular track. The programmatic data includes, for example, data describing the difference between the improved quality version of the video (and/or audio) and the track(s) of the AV content. So, when the programmatic data is combined with (e.g., added to) the AV content, the improved quality video (and/or audio) is obtained.

### HDTV Version Video

The AV content can be enhanced to create an HDTV (High Definition TV) version of the AV content by using programmatic data in the form of an additional track(s) or streams(s). As the AV content is received, programmatic data control module 108 adds in additional detail (based on the programmatic data) to the video track of the AV content. This additional detail includes the additional descriptive information that is the difference between the HDTV version of the video and the version included in the video track of the AV content. In other words, the programmatic data includes the “delta” or difference that, when added to the video track, results in the HDTV version of the video. These differences could include, for example, both the “larger” screen area not shown in the NTSC or PAL version of the AV content but supported by HDTV and the increase in quality that state of the art compression provides over older “standards” (e.g., over MPEG-2).

### Different Aspect Ratios

The AV content can be altered to be any of multiple different aspect ratios (for example, 4:3, 1.85:1, 2.35:1, and so forth). Programmatic data control module 108 re-formats the AV stream to the desired aspect ratio prior to content player 102 outputting the AV output. By re-formatting the AV stream at content player 102, different versions of the AV content (the different versions having different aspect ratios) need not be maintained as separate video tracks.

The Different Aspect Ratios functionality allows multiple different aspect ratios to be easily supported on the same media source. For example, multiple different aspect ratios can be supported on the same side of a DVD (rather than having one disc recorded using a first aspect ratio while the other disc is recorded using another aspect ratio).

In one implementation, the video track of the AV content is the largest of the possible dimensions supported by the Different Aspect Ratios functionality (that is, the video track includes all of the data that would be needed to generate any of the supported aspect ratios). Upon receiving the video track, programmatic data control module 108 converts the data in the video track to the appropriate dimension by removing those portions of the data that are not needed for the desired aspect ratio. This removal may be a straightforward algorithm (e.g., remove the data for certain rows or columns of pixels in the images represented by the data on the video track), or alternatively may incorporate additional intelligence. For example, when converting to the 4:3 aspect ratio it may not always be desirable to remove the same rows and/or columns of pixels in the images represented by the data on the video track, but rather to remove different rows and/or columns for different images. In such situations, which rows and/or columns of pixels are to be removed from which images represented by the data on the video track is identified in the programmatic data.

Using the programmatic data, many different aspect ratios can be supported on the same media source (e.g., the same DVD). For example, the “normal” DVD could be the 4:3 aspect ratio “Pan & Scan” which only shows a portion of the movie window. If the user has an HDTV, they can specify the 16:9 “wide screen” format and the additional data required for the 16:9 wide screen format will be obtained from the programmatic data. In this way, users with legacy equipment have a good version for them (e.g., 4:3 Pan & Scan) and users with new equipment have a good version (e.g., 16:9 widescreen) for them.

### Popup Information

The programmatic data can include popup images and/or text that overlay the video content during playback. The popup images are incorporated into the video content, and can be displayed “on top” of the video content. The popup images and/or text may be always displayed or alternatively may be displayed only in response to a particular action (e.g., the user activating a button on a remote control, or picking up the remote control). The popup images and/or text may include any of a variety of information, such as descriptions of people, places or things, actors' biographies, music soundtrack information, director's notes, set information, links (e.g., uniform resource locators (URLs)) to other sources of information, and so forth.

By way of example, the popup information may include trivia related to the actors in the AV content and the locations at which the AV content was filmed. This trivia is then displayed to the user as AV content is played back. Which trivia is to be displayed at which times, as well as the location of the trivia on the display, is identified in the programmatic data.

By way of another example, the popup information may include descriptions of clothing or furniture being displayed as part of the AV content. The user is then able to automatically purchase particular clothing or furniture being displayed by selecting (e.g., “clicking” on) the popup information. When the user selects the popup information, programmatic data control module 108 uses the programmatic data to identify a link (e.g., a URL) and communicates with the device identified by the link to purchase the particular clothing or furniture. Additional information may also need to be input by the user in order to proceed with such purchases (e.g., the desired size or color of an item, billing and/or shipping addresses, credit card number, etc.), or alternatively such information may already be available (e.g., previously stored in content player 102 by the user, or at the server to which the popup information links). The popup information can overlay on top of the AV content opaquely or semi-transparently (e.g., alpha blended) using any of a variety of well-known techniques.

### Infopause

The Infopause functionality is similar to the Popup Information functionality, but differs in that the popup information is displayed to the user only when playback of the AV content is paused. Thus, using the Infopause functionality, the user is not distracted by the popup information while the AV content is playing, but is presented with the popup information whenever he or she pauses the playback (assuming there is popup information to be displayed at the point where the user pauses playback of the AV content). As in the Popup Information functionality, any of a variety of information or text can be displayed to the user, such as actors' biographies, music soundtrack information, director's notes, set information, and so forth, and the information may be linked (e.g., allowing purchase of the music soundtrack, clothing or furniture being displayed during the pause, etc.).

### 360 Degree Pause

When playback of the AV content is paused, the user can rotate the camera around the scene from a fixed location within the scene at the point the AV content is paused. This pausing may be, for example, the typical pausing of the content playback achieved by pressing the “pause” button on a remote control. This camera movement is as if the camera shooting the current scene of the AV content (when paused) were to remain in its current location but could be rotated, essentially allowing the user to pan to the left or right (and optionally up or down) around the scene. This movement can be, for example, a full 360 degrees (although alternatively less than 360 degrees of rotation could be provided if desired). When playback of the AV content is paused, programmatic data control module 108 uses the programmatic data to present the 360 degree scene.

The programmatic data representing the 360 degree scene data can be a separate video track or stream received from the media source that can be played back to present the full 3D scene, or alternatively the programmatic data may be used by programmatic data control module 108 to generate the 360 degree scene presentation. For example, the 360 degree views not included in the scene of the AV content can be generated in accordance with the “Virtual Walkthrough” (e.g., using video textures as described in A. Schödl, R. Szeliski, D. H. Salesin, and I. Essa, “Video Textures”, Computer Graphics (SIGGRAPH'2000) Proceedings, pages 489-498, New Orleans, July 2000), or QuickTime VR (available from Apple Computer, Inc. of Cupertino, Calif.).

The user may be able to pause playback of the AV content at any point and rotate the camera around the scene, or alternatively the user may be restricted to rotating through the scene at only particular points of the AV content. For example, the AV content and/or programmatic data developer may desire to restrict the user to being able to rotate the camera around the scene at only certain points of the AV content.

### 360 Degree Playback

The 360 Degree Playback functionality is similar to the 360 Degree Pause functionality, but differs in that it allows a user to rotate the camera around the scene 360 degrees during playback of the AV content. Thus, using the 360 Degree Playback functionality, the user can rotate the camera around the scene at any point during playback of the AV content, or alternatively only at particular points of the AV content.

### Intelligent Scanning

The programmatic data includes data that identifies important parts of the AV content, such as scenes that are important for the plot of a movie or television program. By including such a mark-up of important parts in the programmatic data, a user can scan forward and backward through these important parts of the AV content instead of skipping multiples of linear frames for fast forwarding or rewinding. For example, the user can scan forward to the next important interaction between two characters and content player 102 will start playing the scene at the normal “play” rate. When the user is ready, he or she can then scan forward to the next important plot point (e.g., by pressing a button).

Additionally, multiple sets of programmatic data for the Intelligent Scanning functionality may be associated with the same AV content. For example, there may be various sub-plots throughout a movie or television program and the programmatic data can identify the starting points for scenes important to each of these sub-plots, thereby allowing the user to easily scan through and play back the scenes for each sub-plot. By way of another example, there may be particular characters or actors that appear in various scenes throughout the movie or television program. The programmatic data can identify the starting points for scenes including particular characters and/or actors, thereby allowing the user to easily scan through and play back the scenes including each of the particular characters and/or actors.

Furthermore, the programmatic data may also include stopping points for each important part. In such embodiments, when the user invokes the Intelligent Scanning functionality, playback of the AV content could be fast forwarded to the next scene important for the plot of a movie or television program. After that scene has been played back (the stopping point for the scene having been identified in the programmatic data), the playback can automatically scan forward to the next scene important for the plot and playback of that scene can begin.

### Free Camera

The Free Camera functionality is similar to the 360 Degree Playback functionality, but differs in that the Free Camera functionality allows the camera to be moved to different locations in the scene. Thus, rather than being limited to rotating the camera (e.g., panning left, right, up, down, etc.) from a fixed position, the camera position can be moved. In some embodiments the camera position can be moved to any position within (or possibly even outside) the scene, while in alternate embodiments the camera position can be moved to only particular positions (e.g., positions that the AV content designer chooses to allow).

The programmatic data representing the Free Camera scene data can be a separate track or stream received from the media source that can be played back to present the scenes viewed using the Free Camera functionality, or alternatively the programmatic data may be used by programmatic data control module 108 to generate the scene presentation resulting form movement of the camera. For example, when the camera position is moved, the new view of the scene from the new position can be generated using Lumigraph data (e.g., as described in S. J. Gortler, R. Grzeszczuk, R. Szeliski, and M. F. Cohen, “The Lumigraph”, Computer Graphics Proceedings, Annual Conference Series, pages 43-54, Proc. SIGGRAPH'96 (New Orleans), August 1996). Given the new position of the camera, the camera view can then be rotated (e.g., panning left, right, up, down, etc.) from that position as discussed above with regard to the 360 Degree Playback functionality.

### Virtual Walkthrough on Rails

The programmatic data includes data that allows a pre-determined tour of a scene or areas beyond a scene. Analogous to the Free Camera functionality, the programmatic data representing the tour can be a separate track or stream received from the media source that can be played back to present the tour, or alternatively the programmatic data may be used by programmatic data control module 108 to generate the tour. The tour can optionally include audio as well (e.g., sounds of villagers going about their business, sounds of animals or weather, the voice of a “tour guide” pointing out various features scene from the video of the tour, etc.). The user can exit the tour by pressing, for example, a stop button or a play button (e.g., the play button causing playback of the AV content to resume).

The Virtual Walkthrough on Rails functionality allows the user to, for example, explore scenes or areas related to a current scene in additional detail. For example, during playback of a movie a particular scene may occur in a particular village. If the user desires to see more information about this particular village, he or she could invoke the Virtual Walkthrough on Rails functionality to take a tour of the particular village, then resume playback of the AV content.

### Freeform Exploration of the World

The Freeform Exploration of the World functionality is similar to the Virtual Walkthrough on Rails functionality, but differs in that the user is able to move around in directions and to areas that he or she desires, rather than being limited to the tour as in the Virtual Walkthrough on Rails functionality. The Freeform Exploration of the World functionality allows, for example, the user to explore scenes or areas as he or she desires, such as to explore a particular village rather than being limited to a particular tour of that village.

### Multiplayer Worlds

The Multiplayer Worlds functionality is similar to the Freeform Exploration of the World functionality, allowing the user to explore scenes or areas as he or she desires. Additionally, other users (e.g., using other content players 102) are allowed to explore scenes or areas as they desire, and the various users are able to see one another and interact with one another within the scenes or areas.

The Multiplayer Worlds functionality may optionally involve the content player(s) 102 communicating with one or more server devices. Such server devices may control the world (e.g., scenes and areas) accessible to the various users, maintain records of which users are in the world, and maintain records of where the various users are located in the world so that the users can view one another in the world. Such server devices may also coordinate or facilitate the users communicating with one another.

Additionally, notifications may be provided to the user regarding actions going on in the world that may correspond to events that are occurring (or have occurred or are to occur in the future) in the story being told by the AV content during playback.

Thus, it can be seen that the Multiplayer Worlds functionality allows the AV content to operate as a launching pad for a massively multiplayer (MMP) world or game that many users can interact with and explore concurrently.

### Takeover Action

The programmatic data includes data that allows a user to play along with the linear story of the AV content as a virtual actor. This may involve compositing a virtual actor into the scene or action. The user's actions may have significant impact on the storyline or characters, or the user can “let go” of the controls and the linear story will progress as normal. By way of example, a horror film might let a user “play” any of the characters at any time during the story, but then allow the user to “let go” of control to see what happens next. The user's actions and the results thereof may be composited onto the linear AV content or be completely rendered on-the-fly from a different point of view not shown in the AV content. Optionally, completely new storylines can be pursued by the user that can be tangential to the story of the linear AV content. The new views resulting from the user's actions can be generated in any of a variety of manners, analogous to the Free Camera functionality discussed above.

The Takeover Action functionality may also result in different storylines for the linear AV content. For example, if the linear AV content were to be paused at a point where the hero is to jump onto a moving truck, the user may be able to take over the action of the hero and try to make the jump himself or herself (e.g., using the buttons on a remote control or game controller to control the hero's actions). If, when the user is controlling the hero, the jump is not made, then an alternate storyline may be followed for the AV content.

### Compositing of Dynamic Rendered Data into Linear AV Scene

To take the Freeform Exploration of the World functionality and/or Multiplayer Worlds functionality further, the users' actions may be integrated and “composited” into the AV content. For example, if a user, while interacting in a village during the Freeform Exploration of the World functionality, burns down a house in a village, the next time the user plays the AV content of the movie, that house appears destroyed when the characters in the AV content walk past it in the movie.

This can be done, for example, by the programmatic data including data for the house in the village having been destroyed. Programmatic data control module can composite the rendered scene of the destroyed village with the AV content, allowing this alternate village to be displayed.

### Playalong with Linear Story

The programmatic data includes data that allows a user to take over control of the action in the AV content in a limited way that does not change the linear story of the AV content. This is similar to the Takeover Action functionality, but specifically limits the user's control so that it does not change the linear story of the AV content. For example, following the jumping example discussed above in the Takeover Action functionality, if the hero were supposed to make the jump but under the user's control the hero were to miss the jump, then a new linear AV stream may be displayed that fuses the results into the main story of the AV content. By way of example, rather than arriving at a particular destination as a result of jumping onto the moving truck, the hero may arrive at that destination as a result of hitching a ride with a passerby or stealing a motorcycle.

The user's actions as a result of controlling characters using the Playalong with Linear Story functionality may optionally be composited into the linear AV content as discussed above in the Compositing of Dynamic Rendered Data into Linear AV Scene functionality.

Multiform Stories

The programmatic data can include data that allows a user to select a different storyline or viewpoint of the same story dynamically as the base story is told by playback of the AV content. For example, while watching a murder mystery, the user may be able to select a different character in the middle of a scene and watch the rest of the story unfold from their point of view—possibly altering the original, unaltered “linear” story. The user is able to fast forward/rewind in that new track, possibly finding different backstory or a different final ending (or means to the same ending) as the base story. The new views resulting from the user's actions can be generated in any of a variety of manners, analogous to the Free Camera functionality discussed above (e.g., as tracks already available from the media source, or generated on-the-fly by content player 102).

### Character Innerdialog

The programmatic data can include data that allows a user to hear the inner dialog or motivations of an onscreen character(s) that are not played as part of the regular audio stream of the AV content. The inner dialog or motivations can be played back, for example, through the speakers of a headset. The programmatic data can include one or more additional audio tracks and/or audio streams that include the audio for the inner dialog or motivations.

Additionally, the user may optionally be able to choose one or more characters from multiple characters (typically onscreen characters, but may include characters not being shown in the scene) and have only the inner dialog or motivations for that character played back. The selection can be performed in a variety of manners, such as by using a remote control or game controller to move an on-display cursor and allow a “click” using a button or trigger while the on-display cursor is on one of the characters result in selection of that character, having buttons and/or triggers on a remote control or game controller assigned to particular user-selectable characters, having another on-display selection interface (such as a pull-down menu, text entry field, radio buttons or check boxes, etc.). The user may optionally be allowed to select different characters in the same manner as playback of the AV content continues. Furthermore, in certain embodiments, the inner dialog or motivations for multiple different characters may be presented to the user concurrently. The audio for these different inner dialogs or motivations may be combined together, or alternatively may be presented in different manners (e.g., the inner dialog or motivations for one character played back in a left speaker of a headset, while the inner dialog or motivations of for another character are played back in a right speaker of the headset).

### Character Interaction

The programmatic data can include data that allows a user to interact with the onscreen characters of the linear AV content such that the user can influence the character while the linear story of the AV content unfolds (possibly causing the onscreen character to behave in a different manner). For example, a dating television program or movie may allow the user to “chat” with the onscreen character while the character is flirting with another onscreen character. The user's dialog with the onscreen character can influence the character's conversation, mood, final choice, and so forth. The user can interact with the onscreen character(s) in a variety of manners, such as using a remote control or game controller, a headset with a microphone, and so forth.

### Displaying Simultaneous Action

The programmatic data can include data that allows a user to dynamically select different screens to appear concurrently giving different information about the linear story of the AV content simultaneously. Which screens are displayed at any particular time can be chosen by the user, and can change as the story of the AV content progresses. For example, popup contextual information that is overlaid on the video about the details of the scene or actor may be chosen by the user; or possible plot enhancing information (such as a camera from the point of view of the killer waiting in the woods can be brought up while watching the campers around the fire are telling ghost stories).

In order to display such multiple screens concurrently, the display is separated into two or more regions, each region being for a different screen that is to be displayed. These different regions may be of the same or different sizes, and the sizes may be user-selectable.

### Automatic Recap or Summary

The programmatic data can include data that is a mark-up of plot or important information in the AV content. This mark-up can be, for example, a reference to important scenes of the AV content. A user is thus able to view a “recap” of the “plot points” of the AV content when starting from a point in the middle of the stream. The recap can also serve to give a digested version or summary of the entire AV Stream.

By way of example, if the user begins watching the AV content in the middle of the content, he or she can first be presented with the automatic recap or summary which presents the import scenes of the AV content that have occurred up to the point the user is going to begin watching the AV content. This allows the user to receive a summary of the important parts of the AV content that have occurred up to the point at which the user is going to begin watching the AV content.

In one implementation, the Automatic Recap or Summary functionality allows the user to resume playback of the AV content at a later time, and be presented with a recap of the AV content up to the point where he or she previously stopped playback of the AV content. For example, the user may begin watching the AV content on Monday, and then stop playback at some point (e.g., in approximately the middle of the movie or television program). This stopping location can be remembered by content player 102 (e.g., stored on a memory device of content player 102). If the user desires to resume playback on Tuesday evening, he or she can have a summary or recap of the portions he or she has already seen automatically presented to him or her, then have playback of the AV content resume at the location at which he or she stopped playback on Monday.

### Animated Pause

The programmatic data can include data that allows elements in a scene to continue moving even though playback of the AV content has been paused. For example, a user can pause on a scene and the actors will stop moving, but the waterfall in the background can still move, birds chirp, music plays, and so forth. The plot is “frozen” and not progressing, but some of the scene can still be displayed or played as moving. The views displayed to and the sounds played to the user with the Animated Pause functionality can be generated in any of a variety of manners, analogous to the Free Camera functionality discussed above (e.g., as tracks already available from the media source, or generated on-the-fly by content player 102).

### Different Levels of Maturity in Content

The programmatic data can include data that represents one or more variations of portions of the AV content. This allows different versions or editions of the AV content to be played back in different situations (e.g., for different audiences). For example, a particular DVD can be R-Rated, but when played by a child without access to the parental “lockout” code, the version they see would be similar to the “made-for-TV” version: expletives either deleted or dubbed over and mature scenes removed (or even altered). The programmatic data can include, for example, different linear “alternative” streams for one or more of the different versions that may be played back, or alternatively the different versions can be generated on-the-fly analogous to the Free Camera functionality discussed above.

### Episodic Download of Additional Content

The programmatic data can include data that allows the user to access additional episodic content associated with the AV content. For example, additional scenes, additional audio tracks or audio streams, the programmatic data for other enhanced functionality described herein, and so forth may be available to the user. The programmatic data can include, for example links (e.g., URLs) that when selected direct content player 102 to a device (e.g., a remote device via the Internet) from which the additional episodic content associated with the AV content can be obtained. The source of such additional episodic content can thus be an additional media source 104.

The episodic download of additional content allows, for example, expanded scenes to be presented to the user, a director's cut version of the AV content to be presented to the user, humorous outtakes to be presented to the user, and so forth.

Optionally, an additional fee may be charged for access to the additional episodic content.

### Head Mounted Display and 3D Spatialization Data

The programmatic data can include data that is 3-Dimensional (3D) spatialization data of the AV content. When the user is using a display device(s) that can give stereoscopy (Head Mounted Displays, shutter glasses, etc), content 11 player 102 can render the appropriate programmatic data to allow the 3D playback. The programmatic data can include the 3D spatialization data for one or more scenes of the AV content.

Example Data Structure

The programmatic data and AV content can be maintained and transmitted in accordance with any of a variety of formats. This section illustrates example formats in which the programmatic data and AV content can be maintained and transmitted. It is to be appreciated that these formats are only examples, and that other formats can alternatively be used.

Table I illustrates an example format for AV content. In Table I, the AV content is a data stream that includes audio and video data, as well as other data related to the audio and video data.

TABLE I

| Field | Description |
|---|---|
| Video | Includes the data for the video portion of the AV content. |
| | Typically, the data is compressed, such as using any of the |
| | versions of MPEG (Moving Pictures Experts Group), such as |
| | MPEG-1, MPEG-2, or MPEG-4, WMV (Windows Media |
| | Video), and so forth. May optionally include multiple tracks |
| | for multiple different camera views or angles. |
| Audio | Includes the data for the audio portion of the AV content. |
| | The audio can be in one of different types, such as Mono, |
| | Stereo, Surround, Dolby Digital 5.1, etc. May include |
| | multiple audio tracks in different languages, as well as a |
| | “commentary”audio track (e.g., Directors' |
| | commentary, actors'commentary, etc.). The data |
| | may be in uncompressed form or compressed form |
| | (e.g., compressed using WMA (Windows Media Audio), |
| | MP3 (MPEG Audio Layer-3), etc.). |
| Textual | Includes textual data corresponding to the AV content. |
| | For example, may include subtitles in one or more languages. |
| Positional | Includes various data regarding the AV content. For |
| Data | example, may include DVD track/chapter information, time |
| | codes, SMPTE (Society of Motion Picture and Television |
| | Engineers) code, byte position of an AV stream, etc. |

Table II illustrates an example format for programmatic data. Various fields are described in Table II. It is to be appreciated that not all programmatic data need include values for all of the fields in Table II, or even include all of the fields in Table II. For example, if particular programmatic data does not support the Different Levels of Maturity in Content functionality, then the Different Levels of Content for Different Ratings field may be left blank and/or may not be included in the data structure. It should also be noted that the data in different fields of Table II can be used for multiple enhanced functionalities. For example, the 3D Representational Data in Table II can be used for the 360 Degree Pause functionality, the 360 Degree Playback functionality, the Freeform Exploration of the World functionality, and so forth.

TABLE II

| Field | Description |
|---|---|
| 3D Representational | Includes 3-dimensional representational data used to |
| Data | generate or synthesize a scene. Examples of types of data |
| | that may be included are geometry data, texture data, |
| | lightmap data, shadowmap data, models, and so forth. |
| 360 Degree | Includes the data for 360 degree views not included in the |
| Pictorial | scene of the AV content. Can be in accordance with, for |
| Information | example, the “Virtual Walkthrough”, or QuickTime VR |
| | (available from Apple Computer, Inc. of Cupertino, CA). |
| 2D Information | Includes the data for rendering from another viewpoint not |
| | included in the scene. Can use, for example, Lumigraph |
| | data. |
| Markups | Includes the markup data identifying the plot and/or |
| | important parts of the AV content. |
| Executable | Includes the set of instructions (e.g., the programmatic data |
| | control module) discussed above. |
| Functionality for | Includes data identifying what enhanced functionality is |
| Different Devices | available from the programmatic data based on what |
| | devices are available (e.g., what devices are currently |
| | coupled to the content player). For example, different |
| | functionality may be available depending on whether a |
| | DVD remote control unit is available, a game controller is |
| | available, a headset is available, and so forth. |
| Enhanced | Includes the additional data to enhance the video and/or |
| Video/Audio | audio data of the AV content. May include additional audio channels or |
| | tracks. |
| Informational Data | Includes informational data regarding the AV content. For |
| | example, may include: biographies and filmographies of |
| | actors; links to other movies, directors, actors, etc.; data to |
| | be displayed in pop-ups; URLs or other links to information |
| | that the user can navigate; and so forth. |
| Different Levels of | Includes data identifying which content is to be displayed |
| Content for | for which rating. May be in reference to: MPAA (Motion |
| Different Ratings | Picture Association of America) or MPA (Motion Picture |
| | Association), such as NC-17, R, PG-13, PG, G ratings; |
| | ESRB (Entertainment Software Rating Board), such as T- |
| | Teen, M-Mature, E-Everyone, etc.; user-defined ratings, |
| | such as Primetime TV, Late-night TV, subscription TV, |
| | Made-for-TV, etc. |
| Different Display | Includes the data for displaying video in different display |
| Formats | formats. For example, may include data for: NTSC |
| | (National Television Standards Committee) format or PAL |
| | (Phase Alternating Line) format; widescreen format or |
| | letterbox format or HDTV (High Definition TV) format; |
| | Pan and Scan format; and so forth. |

Example Device

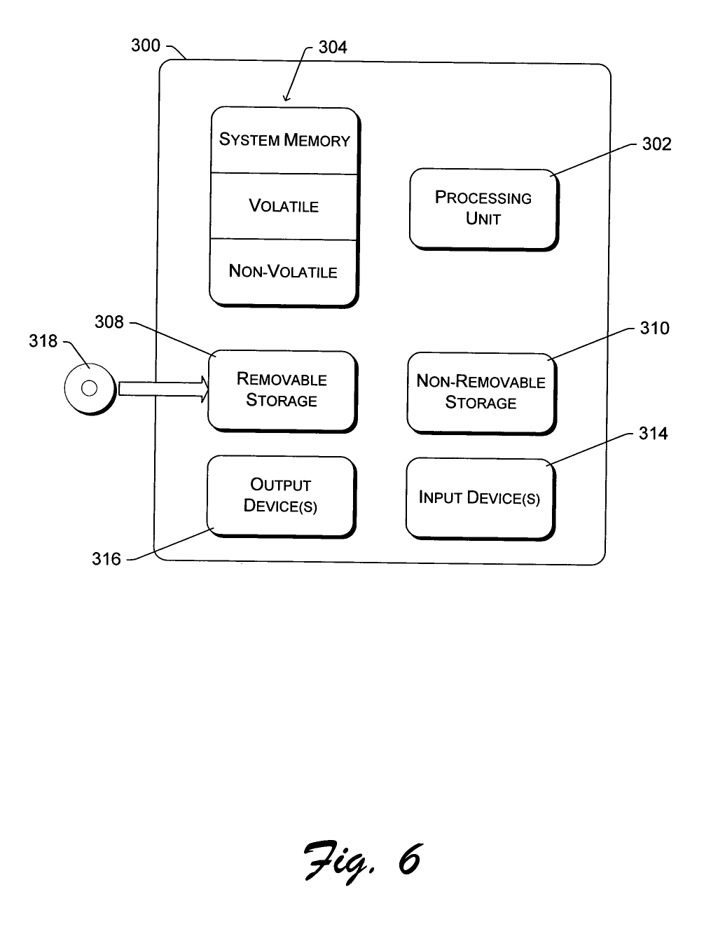

FIG. 6 illustrates an exemplary general device 300. Device 300 can be, for example, a content player 102 of FIG. 1. Device 300 includes at least one processing unit 302 and memory 304. Depending on the exact configuration and type of device, memory 304 may be volatile (such as RAM), non-volatile (such as ROM, flash memory, etc.) or some combination of the two. Device 300 also includes additional storage, such as magnetic or optical disks or tape, in the form of removable storage component 308 and/or non-removable storage component 310. Removable storage component 308 can read from (and optionally write to) removable storage devices, such as magnetic or optical disks or tape. In certain embodiments, removable storage component 308 can read from (and optionally write to) a DVD 318. Device 300 may also include one or more additional processing units, such as a co-processor, a security processor (e.g., to perform security operations, such as encryption and/or decryption operations), and so forth.

Device 300 also includes one or more input devices 314, such as a keyboard, a mouse, a pen, a voice input device (such as a microphone), a touch input device, a game controller, an IR or RF receiver to receive commands from a remote control, and so forth. Device 300 may also include one or more output devices 316, such as a display, one or more speakers, and so forth.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Conclusion

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
obtaining audio/video data from a disc;
presenting the audio/video data to a user;
obtaining a set of software instructions from the disc;
receiving an input from the user; and
executing, in response to the input, one or more instructions of the set of software instructions to determine how to enhance presentation of the audio/video data to the user by using programmatic data associated with the disc.

2. A method as recited in claim 1, further comprising:
obtaining the programmatic data from the disc.

3. A method as recited in claim 1, further comprising:
obtaining the programmatic data from a local storage device.

4. A method as recited in claim 1, further comprising:
obtaining the programmatic data from a remote storage device.

5. A method as recited in claim 1, wherein the user input comprises a user input requesting an action be taken regarding playback of the audio/video data.

6. A method as recited in claim 1, wherein executing the one or more instructions comprises:
identifying a temporal location of the audio/video data currently being played back;
identifying programmatic data corresponding to the identified temporal location; and
executing the one or more instructions to determine how to enhance presentation of the audio/video data currently being played back using the identified programmatic data.

7. A method comprising:
obtaining, from a source, audio/video data for presentation to a user;
obtaining, from the source, a set of instructions associated with the audio/video data;
obtaining programmatic data associated with the audio/video data; and
enhancing presentation of the audio/video data to the user based on the programmatic data processed by the set of instructions.

8. A method as recited in claim 7, wherein obtaining the programmatic data comprises obtaining the programmatic data from the source.

9. A method as recited in claim 7, wherein the source comprises a DVD.

10. A method as recited in claim 7, wherein the enhancing comprises improving the quality of the video data of the audio/video data.

11. A method as recited in claim 7, wherein the enhancing comprises creating an HDTV (High Definition TV) version of the video data of the audio/video data.

12. A method as recited in claim 7, wherein the enhancing comprises converting the video data of the audio/video data to a different aspect ratio.

13. A method as recited in claim 7, wherein the enhancing comprises incorporating popup information into the video data of the audio/video data.

14. A method as recited in claim 7, wherein the enhancing comprises displaying popup information when playback of the audio/video data is paused.

15. A method as recited in claim 7, wherein the enhancing comprises allowing the user to scan through important scenes of the audio/video data, wherein the important scenes are identified in the programmatic data.

16. A method as recited in claim 7, wherein the enhancing comprises presenting, to the user, a summary of important scenes of the audio/video data up to a particular point in the audio/video data.

17. A method as recited in claim 7, wherein the enhancing comprises allowing the user to access additional episodic content associated with the audio/video data.

18. A method as recited in claim 7, wherein the enhancing comprises:
improving the quality of the video data of the audio/video data;
creating an HDTV (High Definition TV) version of the video data of the audio/video data;
converting the video data of the audio/video data to a different aspect ratio;
incorporating popup information into the video data of the audio/video data;
displaying popup information when playback of the audio/video data is paused;
allowing the user to scan through important scenes of the audio/video data, wherein the important scenes are identified in the programmatic data;
presenting, to the user, a summary of important scenes of the audio/video data up to a particular point in the audio/video data; and
allowing the user to access additional episodic content associated with the audio/video data.

19. A method comprising:
receiving audio/video content for playback;
receiving programmatic data associated with the audio/video content; and
executing a set of instructions to enhance the playback of the audio/video content, wherein the enhancement is based at least in part on the programmatic data.

20. A method as recited in claim 19, wherein the audio/video content and the set of instructions are both received from a same source.

21. A method as recited in claim 20, wherein the same source comprises a DVD.

22. A method as recited in claim 19, wherein the receiving programmatic data comprises receiving the programmatic data from a local storage device.

23. A method as recited in claim 19, wherein the receiving programmatic data comprises receiving the programmatic data from a remote device.

24. A method as recited in claim 19, wherein the enhancement comprises improving the quality of the video data of the audio/video content.

25. A method as recited in claim 19, wherein the enhancement comprises creating an HDTV (High Definition TV) version of the video data of the audio/video content.

26. A method as recited in claim 19, wherein the enhancement comprises converting the video data of the audio/video content to a different aspect ratio.

27. A method as recited in claim 19, wherein the enhancement comprises overlaying popup information on the video data of the audio/video content.

28. A method as recited in claim 19, wherein the enhancement comprises displaying popup information when playback of the audio/video content is paused.

29. A method as recited in claim 19, wherein the enhancement comprises allowing the user to scan through important scenes of the audio/video content, wherein the important scenes are identified in the programmatic data.

30. A method as recited in claim 19, wherein the enhancement comprises presenting, to the user, a summary of important scenes of the audio/video content up to a particular point in the audio/video content.

31. A method as recited in claim 19, wherein the enhancement comprises allowing the user to access additional episodic content associated with the audio/video content.

32. One or more computer readable media having stored thereon a plurality of instructions that, when executed by one or more processors, causes the one or more processors to:
access audio/video content obtained from a DVD;
identify a current portion of the audio/video content being played back;
identify programmatic data that corresponds to both the audio/video content and the current portion being played back; and
enhance presentation of the audio/video content based at least in part on the identified programmatic data.

33. One or more computer readable media as recited in claim 32, wherein the programmatic data is also obtained from the DVD.

34. One or more computer readable media as recited in claim 32, wherein the one or more computer readable media comprises the DVD.

35. One or more computer readable media as recited in claim 32, wherein the programmatic data includes a plurality of different portions and the audio/video content includes a plurality of different portions, and wherein different portions of the programmatic data correspond to different portions of the audio/video content.

36. A computer readable media having stored thereon a data structure, comprising:
a first portion containing audio data and video data;
a second portion containing programmatic data;
a third portion containing a plurality of instructions, wherein when executed the plurality of instructions is to determine, based on which of the audio and video data are being presented, which of the programmatic data to process.

37. A computer readable media as recited in claim 36, wherein the programmatic data is processed to improve the quality of the video data.

38. A computer readable media as recited in claim 36, wherein the programmatic data is processed to create an HDTV (High Definition TV) version of the video data.

39. A computer readable media as recited in claim 36, wherein the programmatic data is processed to convert the video data to a different aspect ratio.

40. A computer readable media as recited in claim 36, wherein the programmatic data is processed to incorporate popup information into the video data.

41. A computer readable media as recited in claim 36, wherein the programmatic data is processed to display popup information when playback of the audio data and video data is paused.

42. A computer readable media as recited in claim 36, wherein the programmatic data is processed to allow the user to scan through important scenes of the audio data and video data, wherein the important scenes are identified in the programmatic data.

43. A computer readable media as recited in claim 36, wherein the programmatic data is processed to present, to the user, a summary of important scenes of the audio data and video data up to a particular point in the audio data and video data.

44. A computer readable media as recited in claim 36, wherein the programmatic data is processed to allow the user to access additional episodic content associated with the audio/video data.

45. A method comprising:
obtaining audio/video content to be presented to a user;
obtaining programmatic data associated with the audio/video content; and
executing a set of instructions that use the programmatic data to improve the quality of the video of the audio/video content.

46. A method as recited in claim 45, wherein the set of instructions, the audio/video content, and the programmatic data are all obtained from the same DVD.

47. A method comprising:
obtaining audio/video content to be presented to a user;
obtaining programmatic data associated with the audio/video content; and
executing a set of instructions that use the programmatic data to create an HDTV (High Definition TV) version of the video of the audio/video content.

48. A method as recited in claim 47, wherein the set of instructions, the audio/video content, and the programmatic data are all obtained from the same DVD.

49. A method comprising:
obtaining audio/video content to be presented to a user;
obtaining programmatic data associated with the audio/video content; and
executing a set of instructions that use the programmatic data to convert the video of the audio/video content to a different aspect ratio.

50. A method as recited in claim 49, wherein the set of instructions, the audio/video content, and the programmatic data are all obtained from the same DVD.

51. A method comprising:
obtaining audio/video content to be presented to a user;
obtaining programmatic data associated with the audio/video content; and
executing a set of instructions that use the programmatic data to incorporate popup information into the video of the audio/video content.

52. A method as recited in claim 51, wherein using the programmatic data to incorporate popup information into the video comprises using the programmatic data to overlay the popup information on the video.

53. A method as recited in claim 51, wherein the popup information includes images overlaying the video.

54. A method as recited in claim 51, wherein the popup information includes text overlaying the video.

55. A method as recited in claim 51, wherein the popup information includes a link that, when selected by the user, allows the user to purchase an item being displayed as part of the video.

56. A method as recited in claim 51, wherein the set of instructions, the audio/video content, and the programmatic data are all obtained from the same DVD.

57. A method comprising:
obtaining audio/video content to be presented to a user;
obtaining programmatic data associated with the audio/video content; and
executing a set of instructions that use the programmatic data to display popup information when playback of the audio/video content is paused.

58. A method as recited in claim 57, wherein the popup information includes images overlaying the video.

59. A method as recited in claim 57, wherein the popup information includes text overlaying the video.

60. A method as recited in claim 57, wherein the popup information includes a link that, when selected by the user, allows the user to purchase an item being displayed as part of the video.

61. A method as recited in claim 57, wherein the set of instructions, the audio/video content, and the programmatic data are all obtained from the same DVD.

62. A method comprising:
obtaining audio/video content to be presented to a user;
obtaining programmatic data associated with the audio/video content; and
executing a set of instructions that use the programmatic data to allow the user to scan through important scenes of the audio/video content.

63. A method as recited in claim 62, wherein the programmatic data includes data identifying portions of the audio/video content that are important to the plot of the audio/video content, and wherein the user is allowed to scan through the portions of the audio/video content that are important to the plot.

64. A method as recited in claim 62, wherein the programmatic data includes data identifying portions of the audio/video content that are important to a sub-plot of the audio/video content, and wherein the user is allowed to scan through the portions of the audio/video content that are important to the sub-plot.

65. A method as recited in claim 62, wherein the executing comprises executing the set of instructions that use the programmatic data to allow the user to scan through the important scenes by jumping to a next important scene of a plurality of important scenes in response to a user request.

66. A method as recited in claim 65, wherein the user request comprises activation of a scan button on a remote control.

67. A method as recited in claim 62, wherein executing comprises executing the set of instructions that use the programmatic data to allow the user to scan through the important scenes by playing back only a set of important scenes in response to a single user request.

68. A method as recited in claim 62, wherein the set of instructions, the audio/video content, and the programmatic data are all obtained from the same DVD.

69. A method comprising:
obtaining audio/video content to be presented to a user;
obtaining programmatic data associated with the audio/video content; and
executing a set of instructions that use the programmatic data to present, to the user, a summary of important scenes of the audio/video content up to a particular point in the audio/video content.

70. A method as recited in claim 69, wherein the particular point in the audio/video content comprises the point at which the user indicates playback of the audio/video content is to begin.

71. A method as recited in claim 69, further comprising:
determining a position in the audio/video content where playback of the audio/video content last stopped; and
using the position as the particular point.

72. A method as recited in claim 69, wherein the set of instructions, the audio/video content, and the programmatic data are all obtained from the same DVD.

73. A method comprising:
obtaining audio/video content to be presented to a user;
obtaining programmatic data associated with the audio/video content; and
executing a set of instructions that use the programmatic data to allow the user to access additional episodic content associated with the audio/video content.

74. A method as recited in claim 73, wherein the additional episodic content includes additional scenes of the audio/video content.

75. A method as recited in claim 73, wherein the additional episodic content comprises an additional audio track associated with the audio/video content.

76. A method as recited in claim 73, further comprising charging a fee for access to the additional episodic content.

77. A method as recited in claim 73, wherein the set of instructions, the audio/video content, and the programmatic data are all obtained from the same DVD.

78. A system comprising:
an audio/video playback module to receive audio/video content for playback; and
a programmatic data control module to receive programmatic data associated with the audio/video content and enhance the playback of the audio/video content, wherein the enhancement is based at least in part on the programmatic data.

79. A system as recited in claim 78, wherein the enhancement comprises:
improving the quality of the video data of the audio/video content;
creating an HDTV (High Definition TV) version of the video data of the audio/video content;
converting the video data of the audio/video content to a different aspect ratio;
incorporating popup information into the video data of the audio/video content;
displaying popup information when playback of the audio/video content is paused;
allowing the user to scan through important scenes of the audio/video content, wherein the important scenes are identified in the programmatic data;
presenting, to the user, a summary of important scenes of the audio/video content up to a particular point in the audio/video content; and
allowing the user to access additional episodic content associated with the audio/video content.

80. A system as recited in claim 78, wherein the programmatic data control module, the programmatic data, and the audio/video content are received from the same DVD.
